(19) United States
(12) Patent Application Publication
(10) Pub. No.: US 2025/0234252 A1
(43) Pub. Date: Jul. 17, 2025

(54) AUTHENTICATED ENCRYPTION WITH ASSOCIATED DATA (AEAD) MODES DURING MOBILITY SCENARIOS

(71) Applicant: Lenovo (United States) Inc., Morrisville, NC (US)

(72) Inventors: Sheeba Backia Mary BASKARAN, Friedrichsdorf (DE); Andreas Kunz, Ladenburg (DE)

(21) Appl. No.: 19/097,313

(22) Filed: Apr. 1, 2025

(51) Int. Cl. H04W 36/00; H04W 12/037; H04W 12/041; H04W 36/08

(52) U.S. Cl. CPC H04W 36/0038; H04W 12/037; H04W 12/041; H04W 36/08

(57) ABSTRACT

Various aspects of the present disclosure relate to using authenticated encryption with associated data (AEAD) algorithms for user equipment (UE) mobility scenarios and/or dual connectivity deployments. For example, the technology enhances or updates various mobility procedures (e.g., Xn or N2 handover) to enable communications between an NE and a UE that utilize AEAD algorithms and/or AEAD modes when establishing security contexts for or during the mobility procedures. Thus, a wireless communications system can utilize the benefits of AEAD without introducing issues when a UE moves between NEs (e.g., RAN nodes) that support different security contexts, among other benefits.

### TECHNICAL FIELD

The present disclosure relates to wireless communications, and more specifically to utilizing authentication encryption with associated data (AEAD) modes during mobility scenarios.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

UE mobility involves a handover of a UE from one radio access network (RAN) node to another RAN Node (e.g., a source RAN node to a target RAN node). For example, a mobility scenario for a UE may include an Xn handover, where a UE moves between base stations without changing an associated Access and Mobility Function (AMF), an N2 handover, where the UE moves between base stations and AMFs, and so on.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that implement AEAD algorithms during mobility scenarios.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network entity, a handover command message that contains security information, including one or more AEAD algorithms and one or more AEAD modes associated with the one or more AEAD algorithms, generate an AEAD security key based on the one or more AEAD algorithms and the one or more AEAD modes, and initiate radio resource control (RRC) integrity and ciphering protection using the derived AEAD security key, the one or more AEAD algorithms, and the one or more AEAD modes.

A processor for wireless communication is described. The processor may be configured to, capable of, or operable to perform one or more operations as described herein. For example, the processor may comprise at least one memory and at least one controller coupled with the at least one memory and configured to cause the processor to receive, from a network entity, a handover command message that contains security information, including one or more AEAD algorithms and one or more AEAD modes associated with the one or more AEAD algorithms, generate an AEAD security key based on the one or more AEAD algorithms and the one or more AEAD modes, and initiate RRC integrity and ciphering protection using the derived AEAD security key, the one or more AEAD algorithms, and the one or more AEAD modes.

A method performed or performable by the IoT device is described. The method may comprise receiving, from a network entity, a handover command message that contains security information, including one or more AEAD algorithms and one or more AEAD modes associated with the one or more AEAD algorithms, generating an AEAD security key based on the one or more AEAD algorithms and the one or more AEAD modes, and initiating RRC integrity and ciphering protection using the derived AEAD security key, the one or more AEAD algorithms, and the one or more AEAD modes.

In some implementations of the UE, processor, and method described herein, the UE, processor, and method may further be configured to, capable of, performed, performable, or operable to transmit a handover complete message after initiating the RRC integrity and ciphering protection.

In some implementations of the UE, processor, and method described herein, the handover command message is received from a source radio access network (RAN) node during an Xn handover procedure.

In some implementations of the UE, processor, and method described herein, the handover command message is received from a source RAN node during an N2 handover procedure.

In some implementations of the UE, processor, and method described herein, the handover command message is received from a new serving base station during a RAN notification area (RNA) update procedure.

In some implementations of the UE, processor, and method described herein, the one or more AEAD algorithms include a SNOW-3G based algorithm, an advanced encryption standard (AES) based algorithm, or a ZUC based algorithm.

In some implementations of the UE, processor, and method described herein, the one or more AEAD modes include an encrypt-then-MAC (EtM) mode, a MAC-then-encrypt (MtE) mode, an encryption only mode, or an integrity only mode.

A target RAN node for wireless communication is described. The target RAN node may be configured to, capable of, or operable to perform one or more operations as described herein. For example, the target RAN node may comprise at least one memory and at least one processor coupled with the at least one memory and configured to cause the target RAN node to receive a handover request message that contains security information, including one or more AEAD algorithms and one or more AEAD modes associated with the one or more AEAD algorithms, generate an AEAD security key based on the one or more AEAD algorithms and the one or more AEAD modes, and transmit a handover request acknowledgement message that includes a handover command, wherein the handover command is associated with a selected AEAD algorithm and a selected AEAD mode.

A method performed or performable by the target RAN node is described. The method may comprise receiving a handover request message that contains security information, including one or more AEAD algorithms and one or more AEAD modes associated with the one or more AEAD algorithms, generating an AEAD security key based on the one or more AEAD algorithms and the one or more AEAD modes, and transmitting a handover request acknowledgement message that includes a handover command, wherein the handover command is associated with a selected AEAD algorithm and a selected AEAD mode.

In some implementations of the target RAN node and method described herein, the one or more AEAD algorithms include a SNOW-3G based algorithm, an AES based algorithm, or a ZUC based algorithm.

In some implementations of the target RAN node and method described herein, the one or more AEAD modes include an EtM mode, an MtE mode, an encryption only mode, or an integrity only mode.

In some implementations of the target RAN node and method described herein, the handover request message is received from a source RAN node during an Xn handover procedure.

In some implementations of the target RAN node and method described herein, the target RAN node and method may further be configured to, capable of, performed, performable, or operable to receive a handover complete message from a UE associated with the Xn handover procedure and transmit a path switch request message to a source AMF associated with the source RAN node that includes AEAD capability information for the UE.

In some implementations of the target RAN node and method described herein, the handover request message is received from a target AMF during an N2 handover procedure.

In some implementations of the target RAN node and method described herein, the handover request message is received from an AMF associated with the target RAN node and a source RAN node during an N2 handover procedure.

A base station for wireless communication is described. The base station may be configured to, capable of, or operable to perform one or more operations as described herein. For example, the base station may comprise at least one memory and at least one processor coupled with the at least one memory and configured to cause the base station to receive a path switch message during a RAN notification area (RNA) procedure requested by a UE and initiate a security mode procedure with the UE, wherein the security mode procedure is based on one or more AEAD algorithms and one or more AEAD modes associated with the one or more AEAD algorithms.

A method performed or performable by the base station is described. The method may comprise receiving a path switch message during a RAN notification area (RNA) procedure requested by a UE and initiating a security mode procedure with the UE, wherein the security mode procedure is based on one or more AEAD algorithms and one or more AEAD modes associated with the one or more AEAD algorithms.

In some implementations of the base station and method described herein, the base station receives the path switch message from a source AMF associated with a last serving base station for the UE.

In some implementations of the base station and method described herein, the one or more AEAD algorithms include a SNOW-3G based algorithm, an AES based algorithm, or a ZUC based algorithm.

In some implementations of the base station and method described herein, the one or more AEAD modes include an EtM mode, an MtE mode, an encryption only mode, or an integrity only mode.

A RAN node for wireless communication is described. The RAN node may be configured to, capable of, or operable to perform one or more operations as described herein. For example, the RAN node may comprise at least one memory and at least one processor coupled with the at least one memory and configured to cause the RAN node to receive an addition/modification request from a master RAN node connected to a UE during a dual connectivity procedure, wherein the addition/modification request message indicates security capabilities for the UE, select one or more AEAD algorithms and one or more AEAD modes associated with the one or more AEAD algorithms to apply to communications with the UE based on the security capabilities for the UE, and transmit an addition/modification request acknowledgement message that indicates the selected one or more AEAD algorithms and the one or more AEAD modes.

A method performed or performable by the RAN node is described. The method may comprise receiving an addition/modification request from a master RAN node connected to a UE during a dual connectivity procedure, wherein the addition/modification request message indicates security capabilities for the UE, selecting one or more AEAD algorithms and one or more AEAD modes associated with the one or more AEAD algorithms to apply to communications with the UE based on the security capabilities for the UE, and transmitting an addition/modification request acknowledgement message that indicates the selected one or more AEAD algorithms and the one or more AEAD modes.

In some implementations of the RAN node and method described herein, the one or more AEAD algorithms include a SNOW-3G based algorithm, an AES based algorithm, or a ZUC based algorithm and the one or more AEAD modes include an EtM mode, an MtE mode, an encryption only mode, or an integrity only mode.

### BRIEF DESCRIPTION OF THE DRAWINGS

FIG. 1 illustrates an example of a wireless communications system in accordance with aspects of the present disclosure.

FIG. 2 illustrates an example messaging flow during an Xn handover procedure in accordance with aspects of the present disclosure.

FIG. 3 illustrates a configuration information exchange between RAN nodes in accordance with aspects of the present disclosure.

FIG. 4 illustrates an example messaging flow during an N2 handover procedure in accordance with aspects of the present disclosure.

FIG. 5 illustrates a discovery procedure for AMF peer selection in accordance with aspects of the present disclosure.

FIG. 6 illustrates a configuration transfer procedure in accordance with aspects of the present disclosure.

FIG. 7 illustrates an example messaging flow during an N2 handover procedure in accordance with aspects of the present disclosure.

FIG. 8 illustrates a configuration information exchange between a RAN node and an AMF in accordance with aspects of the present disclosure.

FIG. 9 illustrates an example messaging flow during an RNA Update procedure in accordance with aspects of the present disclosure.

FIG. 10 illustrates an example messaging flow during a Dual Connectivity procedure in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of an NE in accordance with aspects of the present disclosure.

FIG. 14 illustrates a flowchart of a method performed by a UE in accordance with aspects of the present disclosure.

FIG. 15 illustrates a flowchart of a method performed by an NE in accordance with aspects of the present disclosure.

FIG. 16 illustrates a flowchart of a method performed by an NE in accordance with aspects of the present disclosure.

FIG. 17 illustrates a flowchart of a method performed by an NE in accordance with aspects of the present disclosure.

### DETAILED DESCRIPTION

The present disclosure relates to methods, apparatuses, and systems that implement AEAD algorithms when communicating in accordance with one or more mobility scenarios. Often, a UE may move between NEs (e.g., RAN nodes and AMFs) having different capabilities. For example, the UE may move from legacy RAN nodes or AMFs to next generation RAN nodes or AMFs, where the next generation RAN nodes or AMFs support the use of AEAD for security. AEAD algorithms apply a single key for both ciphering and integrity protection and apply a single-pass operation (e.g., using one order or mode) when performing encryption and integrity protection, enabling a higher throughput for data-intensive applications.

Thus, issues may arise when the UE moves between NEs that do not support the use of AEAD and NEs that do support the use of AEAD. For example, when a UE moves from an AEAD-supported base station to a legacy base station, the UE may experience performance degradation and backwards compatibility issues due to different security contexts for the different NEs.

Similarly, dual connectivity scenarios (e.g., multi-RAT dual connectivity) may also introduce issues implementing AEAD when one connected node (e.g., a master node (MN)) supports AEAD, while another connected node (e.g., a secondary node (SN)) does not support AEAD. Such a mixed deployment may lead to inconsistent performance for the UE, since certain communications (RRC and/or UP messaging) are protected via different security algorithms (e.g., AEAD and legacy algorithms) for the different nodes.

The technology described herein enables the use of AEAD algorithms for mobility scenarios and/or dual connectivity deployments. For example, the technology enhances or updates various mobility procedures (e.g., Xn or N2 handover) to enable communications between an NE and a UE that utilize AEAD algorithms and/or AEAD modes when establishing security contexts for or during the mobility procedures. Thus, a wireless communications system can utilize the benefits of AEAD without introducing issues when a UE moves between NEs (e.g., RAN nodes) that support different security contexts, among other benefits.

Aspects of the present disclosure are described in the context of a wireless communications system.

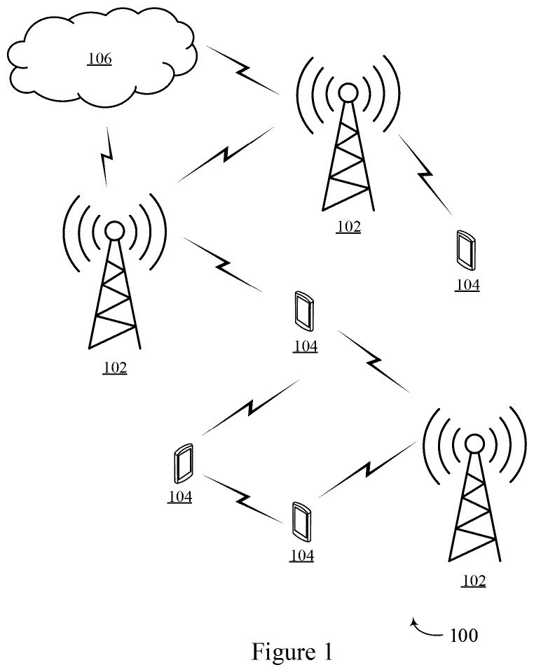

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHZ-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology enables the use of AEAD algorithms during UE mobility scenarios and/or dual connectivity deployments. The UE 104 may be configured and/or capable to support or utilize AEAD algorithms or other combined authenticated encryption algorithms (e.g., Snow-3G, AES, and ZUC) and related different AEAD modes, such as EtM, MtE, encryption only, integrity only, and so on. Similarly, the UE 104 may move between (or connect to) NEs 102 having different security capabilities, such as NEs that support AEAD and NEs that do not support AEAD. The UE 104 may indicate its capabilities to the NE 102 in any non-access stratum (NAS) message or N1 transport message, indicating supported AEAD modes for each supported AEAD algorithm (e.g., via a code for each algorithm).

In some embodiments, the NE 102 may select and use AEAD algorithms and AEAD modes during Xn handover procedures (e.g., inter gNB handover). For example, AEAD algorithms, or other combined authenticated encryption algorithms, may be uniformly applied for access stratum (AS) security (e.g., RRC and UP ciphering and integrity protection) during an Xn handover scenario, where the UE 104 moves between a source gNB (or source RAN) to a target gNB (or target RAN). The UE 104 and the target gNB may uniformly utilize or apply AEAD AS security keys (e.g., RRC key (K_{RRCaead}), UP Key (K_{UPaead})) while using AEAD algorithms for RRC and UP ciphering and integrity protection. Also, a source gNB may select a target gNB having suitable or sufficient security capabilities/configurations (e.g., AEAD capabilities) to serve the UE 104 when the UE 104 supports the use of AEAD cryptographic algorithms (e.g., 128-bit/256-bit/more-bit based security).

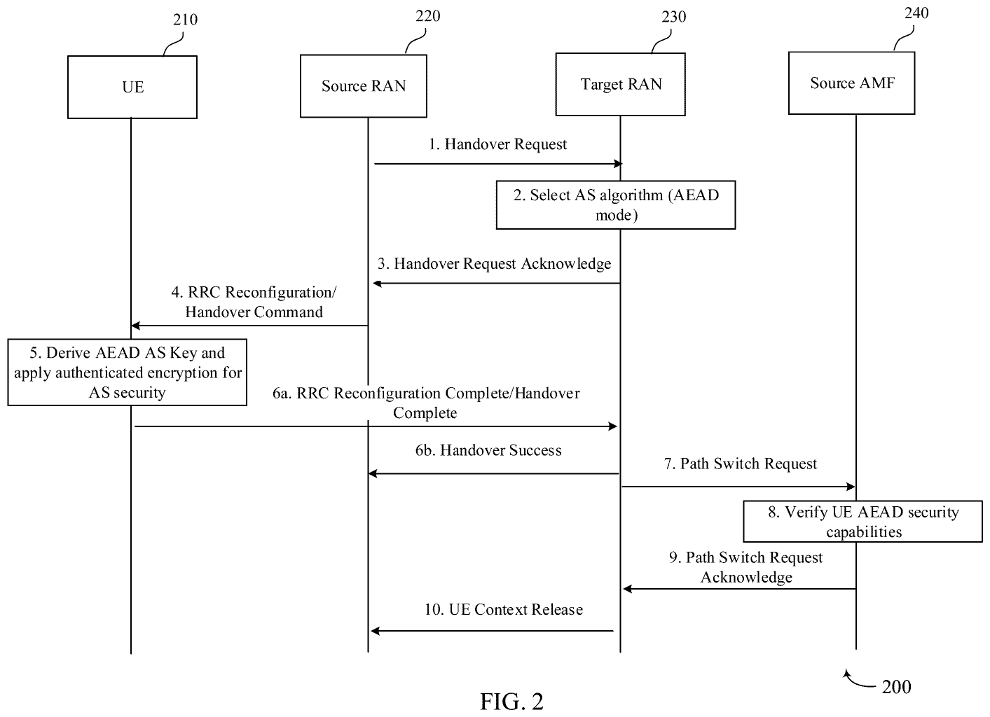

FIG. 2 illustrates an example messaging flow 200 during an Xn handover procedure in accordance with aspects of the present disclosure. The messaging flow 200 may implement various aspects of the present disclosure described herein. For example, the messaging flow 200 may include a UE 210, a source RAN 220, a target RAN 230, and a source AMF 240, which may be examples of UEs, RANs, and AMFs as described herein. In the following description of the messaging flow 200, the operations between the UE 210, the source RAN 220, the target RAN 230, and the source AMF 240 may be performed in different orders or at different times. Some operations may also be omitted, or other operations may be added. Although the UE 210, the source RAN 220, the target RAN 230, and the source AMF 240 are shown performing the operations of the messaging flow 200, some aspects of some operations may also be performed by other entities of the messaging flow 200 or by entities that are not shown in the messaging flow 200, or any combination thereof.

Prior to the Xn handover procedure, the UE 210, as describe herein, may indicate to the source RAN 220 that it has AEAD security capabilities and can support combined authenticated encryption algorithms (e.g., code related to Snow-3G, AES and ZUC based AEAD) and, per AEAD algorithm, associated AEAD modes (e.g., EtM, MtE, encryption only, integrity only, and so on). The UE 210 may transmit the indication via a NAS message/N1 transport/initial NAS message (e.g., Registration Request/Mobility Registration update/Periodic Registration update/any NAS message/PDU session establishment/modification request message, and so on) along with a UE identifier, such as a subscription concealed identifier (SUCI), 5G globally unique temporary identity (5G-GUTI), and so on.

The following are example ciphering algorithms supported by the UE 210: NEA0 (Null ciphering algorithm), 128-NEA1 (e.g., 128-bit SNOW 3G based algorithm), 128-NEA2 (e.g., 128-bit AES based algorithm, 128-NEA3 (e.g., 128-bit ZUC based algorithm), 256-NEA4 (e.g., 256-bit SNOW 3G based algorithm), 256-NEA5 (e.g., 256-bit AES based algorithm), 256-NEA6 (e.g., 256-bit ZUC based algorithm), and so on.

The following are example integrity algorithms supported by the UE 210: NEAO (e.g., Null Integrity protection algorithm), 128-NIA1 (e.g., 128-bit SNOW 3G based algorithm), 128-NIA2 (e.g., 128-bit AES based algorithm), 128-NIA3 (e.g., 128-bit ZUC based algorithm), 256-NIA4 (e.g., 256-bit SNOW 3G based algorithm), 256-NIA5 (e.g., 256-bit AES based algorithm), 256-NIA6 (e.g., 256-bit ZUC based algorithm), and so on.

The following are combined Authenticated Encryption Algorithms supported by the UE 210:256-NCA7 (e.g., 256-bit SNOW 3G based algorithm—AEAD), 256-NCA8 (e.g., 256-bit AES based algorithm—AEAD), 256-NCA9 (e.g., 256-bit ZUC based algorithm—AEAD), and so on (where NCA refers to a next generation combined authenticated encryption algorithm).

In some cases, the UE 210 and various network nodes (e.g., the source RAN 220, the target RAN 230, and the source AMF 240) may perform primary authentication, NAS and AS security establishment (e.g., via a security mode command procedure) and the UE 210 connects to the network. Due to the mobility of the UE 210 or due to other reasons, a serving gNB (e.g., the source RAN 220) may initiate a handover for the UE 210 towards a new target gNB (e.g., the target RAN 230).

At step 1, the source RAN 220 sends a handover request to the target RAN 230. For example, the handover request includes security capabilities for the UE 210, including a supported combined authenticated encryption algorithm list, supported AEAD modes, a “Use AEAD AS key indication,” and/or ciphering and integrity algorithms (e.g., combined authenticated encryption algorithms with associated AEAD modes used by the source RAN 220. As described herein, the AEAD algorithms may be a combined authenticated encryption algorithm (e.g., related to Snow-3G, AES, and/or ZUC) or an authenticated encryption algorithm.

The source RAN 220 may select a target RAN (e.g., the target RAN 230) that supports AEAD algorithms and AEAD modes to facilitate and/or enable uniform security for the UE 210 during the handover (e.g., to ensure the same level of protection (e.g., cryptographic key length, order of encryption/integrity protection and performance) for AS communications.

At step 2, the target RAN 230 selects an AS algorithm (with an associated AEAD mode). For example, the target RAN 230 may determine to select and apply authenticated encryption algorithms (e.g., for AS security, such as RRC integrity and ciphering protection and UP integrity and ciphering protection) when the UE 210 supports AEAD and/or when an operator configuration policy includes authenticated encryption algorithms in a prioritized list. The target RAN 230 derives an AEAD RRC key and AEAD UP key and selects the authenticated encryption algorithm and AEAD mode with a highest priority from the received 5G security capabilities (e.g., based on supported authenticated encryption algorithms and AEAD modes) for the UE 210 and according to the prioritized list of authenticated encryption algorithms and AEAD modes, for both integrity and ciphering algorithms.

In some cases, when the source RAN 220 selects a suitable target RAN (e.g., the target RAN 230) based on its AEAD security capabilities, then the selected target RAN performs the Xn handover to enable the application of a same level of AS security (e.g., RRC and UP) for the UE 210.

At step 3, the target RAN 230 sends a handover request acknowledge message to the source RAN 220. For example, the target RAN 230 sends a handover request acknowledge message that includes a “handover command” with selected authenticated encryption algorithms and AEAD modes for RRC and UP encryption and integrity, along with the “Use AEAD AS key indication.” The handover command may be a transparent container sent by the target RAN 230 to the source RAN 220, which may then be forwarded to the UE 210 by the source RAN 220.

In some cases, the handover command may be integrity protected with a new AEAD RRC key (K_{RRCaead}), using the selected authenticated encryption algorithms and AEAD mode (e.g., int-only) for integrity protection (e.g., when the target RAN 230 selects and uses a 256-bit integrity algorithm). The handover command message may also be ciphered with a new AEAD RRC encryption key (K_{RRCaead}) using the selected authenticated encryption algorithms and AEAD modes for ciphering protection.

At step 4, the source RAN 220 sends a RRC reconfiguration message (e.g., handover command) to the UE 210. For example, the source RAN 220 indicates the selected algorithms (e.g., RRC and UP authenticated encryption algorithms and AEAD modes) in the handover command to the UE 210. When the UE 210 does not receive an indication of a selected AEAD algorithm or AEAD mode, it uses the same algorithms as before the handover (e.g., TS 38.331 for gNB or TS 36.331 for ng-eNB), existing AS keys, and/or uses AEAD AS keys for RRC and UP security as per an earlier AS established connection. Thus, when an Xn handover occurs between the RAN nodes 220, 230, the selected authenticated encryption algorithms and AEAD modes in the target RAN 230 and the “Use AEAD AS key indication” is signaled in the handover command to the UE 210.

At step 5, the UE 210 derives an AEAD AS Key and applied authenticated encryption for AS security. For example, the UE 210 determines to derive and use AEAD AS keys (e.g., an AEAD RRC key (K_{RRCaead}) and an AEAD UP Keys K_{UPaead}) based on the selected authenticated encryption algorithms and AEAD modes for RRC and UP security and/or based on the received “Use AEAD AS key indication” in the handover command message. The UE 210 may determine to use the indicated authenticated encryption algorithms and AEAD modes for ciphering and integrity protection as indicated by the handover command message.

At step 6a, the UE 210 sends an RRC Reconfiguration complete/Handover complete message to the target RAN 230. The UE 210 may utilize the integrity protection with the indicated RRC authenticated encryption algorithm and AEAD modes and the AEAD RRC key (K_{RRCaead}) for the RRC Reconfiguration complete/Handover complete message. At step 6b, the target RAN 230 sends a handover success message to the source RAN 220.

At step 7, the target RAN 230 sends a path switch request to the source AMF 240. For example, the target RAN 230 sends a path switch message that contains information identifying the support of AEAD by the UE 210.

At step 8, the source AMF 240 verifies the AEAD security capabilities of the UE 210. For example, the source AMF 240 determines the information identifying the support of AEAD by the UE 210 matches locally stored AEAD security capabilities for the UE 210.

At step 9, the source AMF 240 sends a path switch request acknowledge message to the target RAN 230. For example, if there is a mismatch in the AEAD security capabilities, the source AMF 240 sends the locally stored AEAD capabilities to the target RAN 230 (and may initiate an alarm to identify the mismatched capabilities).

At step 10, the target RAN 230 sends a UE context release message to the source RAN 220. For example, when the target RAN 230 updates an AS security context of the UE 210 with the 5G security capabilities containing the AEAD security capabilities of the UE 210. In some cases, the target RAN 230 selects authenticated encryption algorithms and AEAD modes with a highest priority from the 5G security capabilities according to a locally configured prioritized list of algorithms (e.g., for both integrity and ciphering algorithms as well as the combined authenticated encryption algorithms). When the AEAD algorithms selected by the target RAN 230 are different from AEAD algorithms used by the source RAN 220, the target RAN 230 initiates the intra-cell handover procedure, including the RRC Connection Reconfiguration procedure indicating the selected authenticated encryption.

In some cases, the transfer of the ciphering and integrity algorithms used by the source RAN 220 along with the “Use AEAD AS key indication” to the target RAN 230 in the handover request message enables the target RAN 230 to decipher and verify the integrity of the RRC Reestablishment Complete message on a signaling radio bearer (e.g., SRB1) in a potential RRC Connection Re-establishment procedure using the AEAD RRC key and indicated authenticated encryption algorithms and AEAD modes. The information may also be used by the target RAN 230 to decide whether to include a new selection of security algorithms (e.g., authenticated encryption algorithms and AEAD modes) in the Handover Command message.

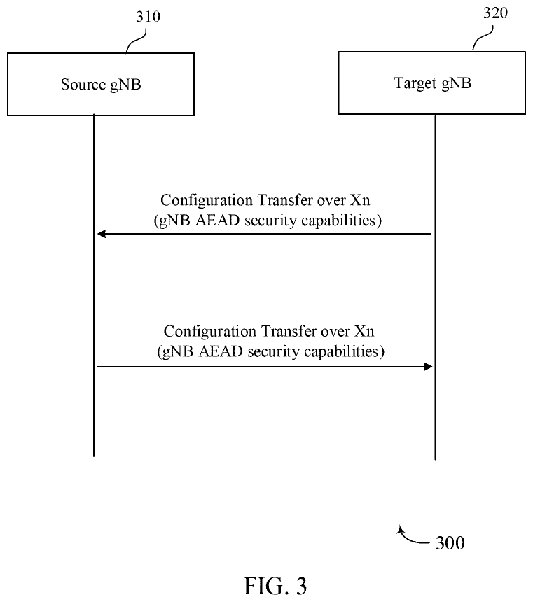

FIG. 3 illustrates a configuration information exchange 300 between RAN nodes in accordance with aspects of the present disclosure. A source gNB 310 and a target gNB 320 may perform a configuration transfer over an Xn interface to exchange supported AEAD security capabilities. As described herein, the transferred security capabilities may include a supported ciphering algorithms list, a supported integrity algorithms list, a supported authenticated encryption algorithms list, supported AEAD modes, AEAD AS Key derivation capabilities (e.g., indicating that the gNB is capable of deriving RRC and AEAD UP security keys for combined AS ciphering and integrity protection (e.g., RRC and UP)), and so on.

In some embodiments, the NE 102 may select and use AEAD algorithms and AEAD modes during N2 handover procedures (e.g., inter gNB handover with an AMF change or an inter-AMF handover). For example, AEAD algorithms, or other combined authenticated encryption algorithms, may be uniformly applied for non-access stratum (NAS) security (e.g., NAS ciphering and integrity protection) and AS security (e.g., RRC and UP ciphering and integrity protection) during an N2 handover scenario, where the UE 104 moves between a source gNB (or source RAN) to a target gNB (or target RAN), along with a change in the AMF (e.g., from a source AMF to a target AMF). The UE 104 and the target AMF may uniformly utilize or apply AEAD NAS security keys (e.g., K_{NASaead}) for NAS ciphering and integrity protection and/or AEAD AS keys for RRC and UP ciphering and integrity protection. Also, a source AMF may select a target AMF having suitable or sufficient security capabilities/configurations (e.g., AEAD capabilities) to serve the UE 104 when the UE 104 supports the use of AEAD cryptographic algorithms (e.g., 128-bit/256-bit/more-bit based security).

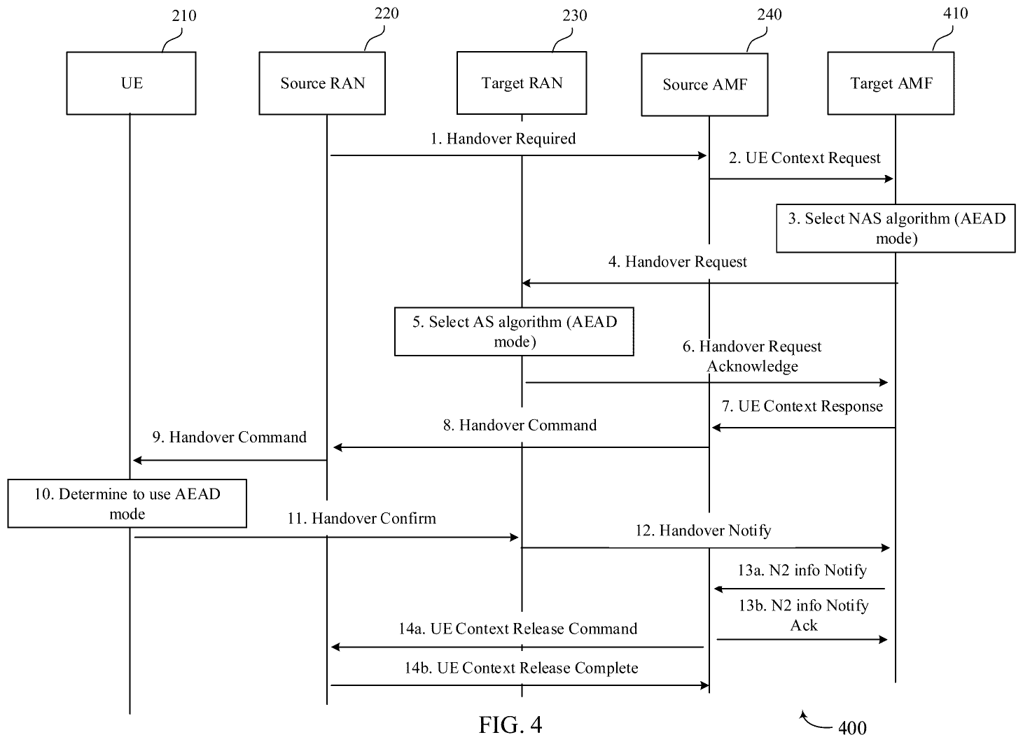

FIG. 4 illustrates an example messaging flow 400 during an N2 handover procedure in accordance with aspects of the present disclosure. The messaging flow 400 may implement various aspects of the present disclosure described herein. For example, the messaging flow 400 may include the UE 210, the source RAN 220, the target RAN 230, the source AMF 240, and a target AMF 410, which may be examples of UEs, RANs, and AMFs as described herein. In the following description of the messaging flow 400, the operations between the UE 210, the source RAN 220, the target RAN 230, the source AMF 240, and the target AMF 410 may be performed in different orders or at different times. Some operations may also be omitted, or other operations may be added. Although the UE 210, the source RAN 220, the target RAN 230, the source AMF 240, and the target AMF 410 are shown performing the operations of the messaging flow 400, some aspects of some operations may also be performed by other entities of the messaging flow 400 or by entities that are not shown in the messaging flow 400, or any combination thereof.

At step 1, the source RAN 220 sends a handover required message to the source AMF 240. For example, the handover required message may include AEAD security capabilities of the UE 210, such as a supported combined authenticated encryption algorithms list, supported AEAD modes, a “Use AEAD AS key indication,” and/or ciphering and integrity algorithms used by the source RAN 220 in the handover required message (e.g., request message). In some cases, the source RAN 220 may send a source to target transport container (STC), which contains the AEAD security capabilities.

At step 2, the source AMF 240 receives the handover request and sends a UE context request to the target AMF 410. The UE context request may be a Namf_Communication_CreateUEContext Request message, which includes the security capabilities of the UE 210, the “Use AEAD NAS key indication” and/or an STC (Used AS algorithms—indicating combined authenticated encryption algorithms, AEAD modes, and the “Use AEAD AS key indication”).

In some cases, the source AMF 240 may select a target AMF (e.g., the target AMF) that supports similar or matching AEAD security capabilities, to ensure a same level of protection (e.g., cryptographic key length, order of encryption/integrity protection and performance, and so on) for the NAS during the N2 handover. Further, the source AMF 240 may select a suitable target AMF based on its AEAD security capabilities (e.g., during peer AMF selection/discovery, as described herein). The target AMF (e.g., the target AMF 410) may perform the N2 handover with a same level of NAS security for the UE 210.

At step 3, the target AMF 410 selects a NAS algorithm (using an associated AEAD mode). For example, the target AMF 410 determines to select and apply a combined authenticated encryption algorithm with a suitable AEAD mode (for NAS security, such as integrity and ciphering protection) based on AEAD security capabilities of the UE 210 and/or based on an operator configuration policy that includes combined authenticated encryption algorithms and AEAD modes in a prioritized list. The target AMF 410 derives an AEAD NAS key (K_{NASaead}), and selects the combined authenticated encryption algorithm and suitable AEAD mode with a highest priority according to the prioritized locally configured list of combined authenticated encryption algorithms (e.g., for both integrity and ciphering algorithms).

At step 4, the target AMF 410 sends a handover request message to the target RAN 230. For example, when the change of AMF (e.g., from the source AMF 240 to the target AMF 410) results in a change of the algorithm for establishing NAS security, the target AMF 410 indicates the selected combined authenticated encryption algorithm along with the selected AEAD Mode to the UE 210 (e.g., using a NAS Container (NASC)), as described herein. The target AMF 410 selects the NAS algorithm having a highest priority according to prioritized lists.

In some cases, such as during a mobility registration update (e.g., using a NAS SMC), the target AMF 410 may indicate the selected combined authenticated encryption algorithm and AEAD mode to the UE 210 along with the “Use AEAD NAS key indication.”

In some cases, the target AMF 410 creates the NASC container, which contains the selected NAS security algorithms, the “Use AEAD AS key indication,” and/or other information (e.g., related to AMF key derivation) and the NAS MAC. For example, the target AMF 410 sends the security capabilities of the UE 210, an STC (Used AS algorithms—(indicating combined authenticated encryption algorithm, AEAD mode, and the “Use AEAD AS key indication”), an NASC (Indicating selected 256-bit Integrity algorithm, 256-bit Ciphering algorithm, and the “Use 256 bit NAS key indication,’ along with other information (e.g., related to AMF key derivation) and the NAS MAC), which may be included in an NGAP HANDOVER REQUEST message to the target RAN 230.

At step 5, the target RAN 230 selects an AS algorithm (and associated AEAD mode). For example, the target RAN 230 receives the STC or NASC and determines to select and apply combined authenticated encryption algorithm and AEAD mode based on security capabilities of the UE 210 and/or an operator configuration policy. The RAN 230 may derive an AEAD RRC key (K_{RRCaead}) and an AEAD UP key (K_{UPaead}). The target RAN 230 may select the combined authenticated encryption algorithm and related AEAD mode according to a prioritized locally configured list of combined authenticated encryption algorithms and related AEAD modes (e.g., for both integrity and ciphering algorithms).

In some cases, the target RAN 230 constructs a target to source transparent container (TSC), which contains the selected combined authenticated encryption algorithm, AEAD mode for AS, and the “Use AEAD AS key indication.”

At step 6, the target RAN 230 sends a handover request acknowledge message to the target AMF 410. For example, the handover request acknowledge message includes the TSC and the NASC, along with other information received in step 4.

At step 7, the target AMF 410 sends a UE context response message to the source AMF 240. For example, the target AMF 410 sends an Namf_Communication_CreateUEContext Response message, which includes the TSC, the NASC, along with other information, as described herein.

At step 8, the source AMF 240 send a handover command message to the source RAN 220. For example, the source AMF 240 sends the TSC, the NASC, along with other information, as described herein, in the handover command message.

At step 9, the source RAN 220 sends a handover command message to the UE 210. For example, the source RAN 220 sends an indication of the combined authenticated encryption algorithms and AEAD modes, the “Use AEAD AS key indication” (e.g., received in the TSC at step 8), along with the received NASC in the handover command message.

At step 10, the UE 210 determines to use an AEAD mode. For example, the UE 210 determines to derive and use an AEAD NAS key (K_{NASaead}) based on the received selected NAS algorithms and/or based on the received “Use AEAD NAS key indication,” as part of the NASC, in the handover command message. The UE 210 may determine to use the indicated combined authenticated encryption algorithm and indicated AEAD mode for NAS ciphering and integrity protection as indicated by the target AMF 410, as part of the NASC, in the handover command message.

The UE 210 may determine to derive and use AEAD AS keys (e.g., AEAD RRC keys (K_{RRCaead}) and AEAD UP Keys (K_{UPaead})) based on the received selected RRC and UP algorithms (e.g., indicating combined authenticated encryption algorithm, AEAD mode) and/or based on the received “Use AEAD AS key indication” in the handover command message. The UE 210 may determine to use the combined authenticated encryption algorithm and indicated AEAD mode for ciphering and integrity protection as indicated in the handover command message. The UE 210 may use the integrity protection with the indicated combined RRC authenticated encryption algorithm and the AEAD RRC integrity key for further RRC connections with the target RAN 230. When there is no selected AEAD algorithms, the UE 210 may use a previous security algorithm, as described herein.

At step 11, the UE 210 sends a handover confirm message to the target RAN 230. For example, the UE 210 may apply the newly selected combined authenticated encryption algorithms and AEAD modes with AEAD RRC keys (K_{RRCaead}).

To complete the N2 handover procedure, at step 12, the target RAN 230 sends a handover notify message to the target AMF 410, the target AMF 410, at step 13a, sends an N2 info notify message (e.g., Namf_Communication_N2InfoNotify) to the source AMF 240, the source AMF 240, at step 13b, sends an N2 info notify acknowledgement message (e.g., Namf_Communication_N2InfoNotify acknowledgement) to the source AMF 240, the source AMF 240, at step 14a, sends a UE context release command to the source RAN 220, and the source RAN 220, at step 14b, sends a UE context release complete message to the source AMF 240.

As described herein, an AMF (e.g., the source AMF 240) may perform peer selection or discovery to select a target AMF (e.g., the target AMF 410). In some embodiments, the AMFs may exchange security capabilities/configurations over an N14 interface. As described herein, the transferred security capabilities may include a supported ciphering algorithms list, a supported integrity algorithms list, a supported authenticated encryption algorithms list, supported AEAD modes, AEAD NAS Key derivation capabilities (e.g., indicating that the AMF is capable of deriving AEAD NAS security keys for combined NAS ciphering and integrity protection), and so on.

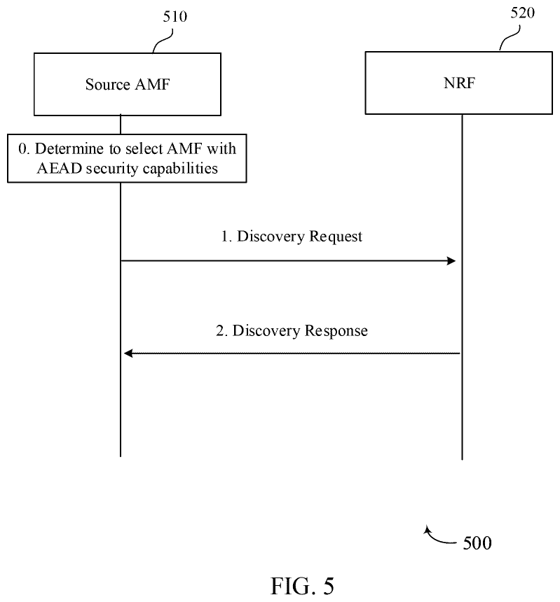

In some embodiments, a network repository function (NRF) may store AEAD security information for AMFs as part of NF profile information stored by the NRF. FIG. 5 illustrates a discovery procedure 500 for AMF peer selection in accordance with aspects of the present disclosure. A source AMF 510, at step 0, may determine to select an AMF having AEAD security capabilities.

At step 1, the source AMF 510 sends a discover request message to an NRF 520. For example, the source AMF 510 sends an Nnrf_NFDiscovery_Request message with target NF service names: “Namf_Communication_CreateUEContext, “N2InfoNotify,” NF type of target NF “AMF,” NF type of the NF service Consumer: “AMF,” and combined Authenticated Encryption/AEAD Security Capabilities (e.g., support of Combined Authenticated Encryption algorithms, support of AEAD modes, support of AEAD NAS Key derivation indication, and so on).

The NRF 520 manages NF profiles. An NF profile may include, for each AMF/AMF instance, the AMF security capabilities (as described herein). The NRF 520 selects the AMFs/AMF instances having the capability to support the combined Authenticated Encryption/AEAD Security Capabilities (support of Combined Authenticated Encryption algorithms, Support of AEAD modes, Support of AEAD NAS Key derivation indication) as indicated by the source AMF 510 in the discover request.

At step 2, the NRF 520 sends a discovery response to the source AMF 510. For example, the NRF 520 sends a Nnrf_NFDiscovery_Response message with AMF Type, AMF Instance ID(s), FQDN or IP addresses of the NF instance, per AMF Instance/AMF list of Combined Authenticated Encryption/AEAD Security Capabilities.

The source AMF 510 may then select a target AMF (or AMF instance) having the most Combined Authenticated Encryption/AEAD Security Capabilities based on the UE Combined Authenticated Encryption/AEAD Security Capabilities, to perform the N2 handover for the UE.

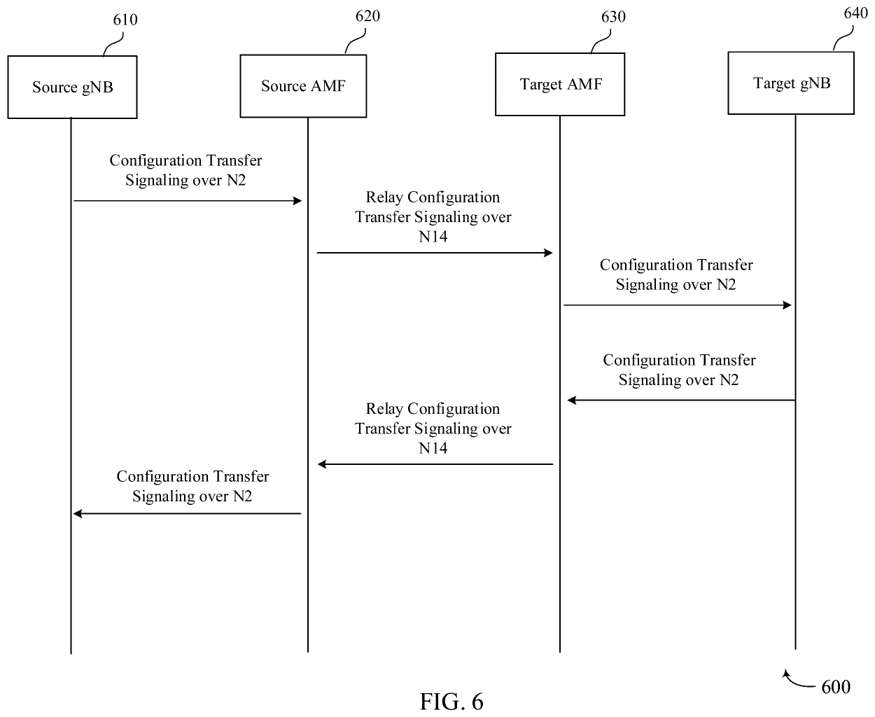

In some embodiments, a configuration transfer may facilitate the exchange of information between RAN nodes or gNBs (e.g., applications supported by the RAN nodes), such as via AMFs associated with the RAN nodes. FIG. 6 illustrates a configuration transfer procedure 600 in accordance with aspects of the present disclosure.

A source gNB 610 transfers its security capabilities via configuration transfer signaling over an N2 interface to its source AMF 620. The source AMF 620 may then transfer (e.g., relay) the security capabilities of the source gNB 610 to a target AMF 630 (e.g., an AMF selected for an N2 handover) via relay configuration transfer signaling over an N14 interface. The target AMF 630 transfers the security capabilities of the source gNB 610 to a target gNB 640 via configuration transfer signaling over an N2 interface.

Similarly, the transfer gNB 640 transfers its security capabilities via configuration transfer signaling over an N2 interface to its target AMF 630. The target AMF 320 may then transfer (e.g., relay) the security capabilities of the target gNB 640 to a source AMF 620 (e.g., a source AMF within an N2 handover) via relay configuration transfer signaling over an N14 interface. The source AMF 620 transfers the security capabilities of the target gNB 640 to a source gNB 610 via configuration transfer signaling over an N2 interface.

In some embodiments, the NE 102 may select and use AEAD algorithms and AEAD modes during N2 handover procedures without an AMF change. For example, AEAD algorithms, or other combined authenticated encryption algorithms, may be uniformly applied for AS security (e.g., RRC and UP ciphering and integrity protection) during an N2 handover scenario, where the UE 104 moves between a source gNB (or source RAN) to a target gNB (or target RAN) without a change in the AMF. The UE 104 and the AMF may uniformly utilize or apply AEAD AS security keys (e.g., K_{ASaead}) for AS ciphering and integrity protection. Also, the AMF may select a target RAN having suitable or sufficient security capabilities/configurations (e.g., AEAD capabilities) to serve the UE 104 when the UE 104 supports the use of AEAD cryptographic algorithms (e.g., 128-bit/256-bit/more-bit based security).

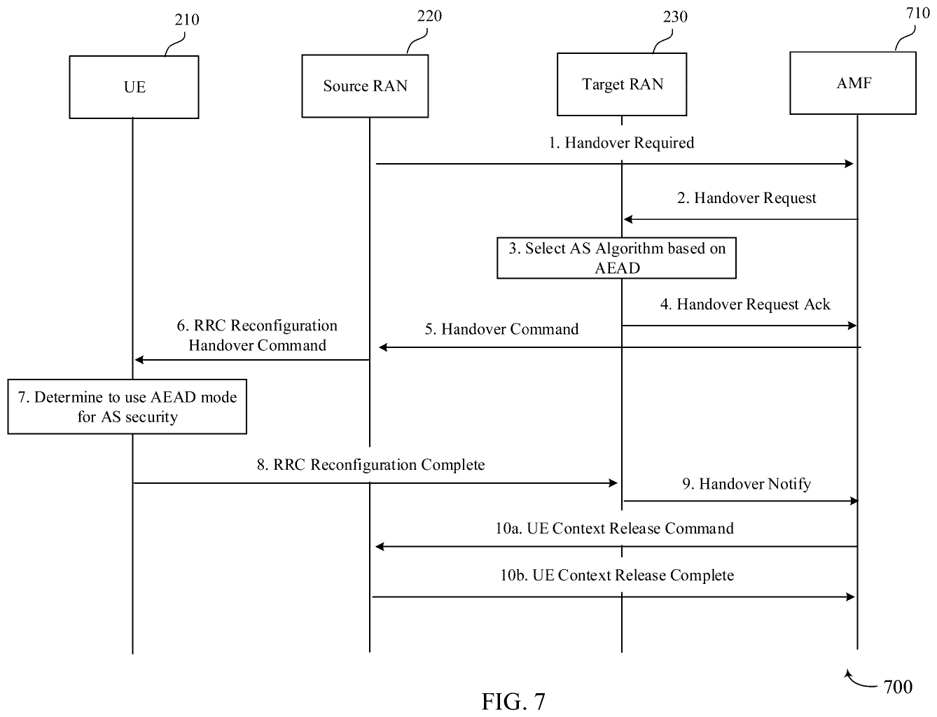

FIG. 7 illustrates an example messaging flow 700 during an N2 handover procedure in accordance with aspects of the present disclosure. The messaging flow 700 may implement various aspects of the present disclosure described herein. For example, the messaging flow 700 may include the UE 210, the source RAN 220, the target RAN 230, and an AMF 710, which may be examples of UEs, RANs, and AMFs as described herein. In the following description of the messaging flow 700, the operations between the UE 210, the source RAN 220, the target RAN 230, and the AMF 710 may be performed in different orders or at different times. Some operations may also be omitted, or other operations may be added. Although the UE 210, the source RAN 220, the target RAN 230 and the AMF 710 are shown performing the operations of the messaging flow 700, some aspects of some operations may also be performed by other entities of the messaging flow 700 or by entities that are not shown in the messaging flow 700, or any combination thereof.

At step 1, the source RAN 22 sends a handover required (e.g., handover request) message to the AMF 710. For example, the handover required message may include AEAD security capabilities of the UE 210, such as a supported combined authenticated encryption algorithms list, supported AEAD modes, a “Use AEAD AS key indication,” and/or ciphering and integrity algorithms used by the source RAN 220 in the handover required message (e.g., request message). In some cases, the source RAN 220 may send a source to target transport container (STC), which contains the AEAD security capabilities.

At step 2, the AMF 710 sends a handover request message to the target RAN 230. For example, the handover request includes the AEAD security capabilities of the UE 210 (e.g., with a prioritized list of supported AEAS algorithms and supported AEAD modes), an STC, and so on. The AMF 710, as described herein, selects the target RAN 230 when the target RAN 230 supports the AEAD security capabilities shared by the UE 210.

At step 3, the target RAN 230 selects an AS algorithm (e.g., AEAD based). For example, upon receiving the handover request (e.g., an NGAP HANDOVER REQUEST), the target RAN 230 receives the STC or NASC and determines to select and apply combined authenticated encryption algorithm and AEAD mode based on security capabilities of the UE 210 and/or an operator configuration policy. The RAN 230 may derive an AEAD RRC key (K_{RRCaead}) and an AEAD UP key (K_{UPaead}). The target RAN 230 may select the combined authenticated encryption algorithm and related AEAD mode according to a prioritized locally configured list of combined authenticated encryption algorithms and related AEAD modes (e.g., for both integrity and ciphering algorithms).

In some cases, the target RAN 230 constructs a target to source transparent container (TSC), which contains the selected combined authenticated encryption algorithm, AEAD mode for AS, and the “Use AEAD AS key indication.”

At step 4, the target RAN 230 sends a handover request acknowledgement to the AMF 710. The handover request acknowledgement may include the TSC and/or other information.

At step 5, the AMF 710 sends a handover command message to the source RAN 220. For example, the AMF 710 sends the received TSC to the source RAN 220.

At step 6, the source RAN 220 send an RRC Reconfiguration (e.g., handover command) to the UE 210 For example, the source RAN 220 sends an indication of the combined authenticated encryption algorithms and AEAD modes, the “Use AEAD AS key indication” (e.g., received in the TSC at step 5), along with the received NASC in the handover command message.

At step 7, the UE 210 determines to use the AEAD mode for AS security. For example, the UE 210 determines to derive and use an AEAD AS key (e.g., K_{RRCaead} and K_{UPaead}) based on the received selected AS algorithms and/or based on the received “Use AEAD AS key indication,” as part of the NASC, in the handover command message. The UE 210 may determine to use the indicated combined authenticated encryption algorithm and indicated AEAD mode for AS ciphering and integrity protection as indicated by the AMF 710, as part of the NASC, in the handover command message.

The UE 210 may determine to use the combined authenticated encryption algorithm and indicated AEAD mode for ciphering and integrity protection as indicated in the handover command message. The UE 210 may use the integrity protection with the indicated combined RRC authenticated encryption algorithm and the AEAD RRC integrity key for further RRC connections with the target RAN 230. When there is no selected AEAD algorithms, the UE 210 may use a previous security algorithm, as described herein.

At step 8, the UE 210 sends an RRC Reconfiguration Complete message to the target RAN 230. For example, the UE 210 applies the newly selected authenticated encryption algorithms and AEAD modes to RRC integrity and ciphering with the AEAD RRC keys (K_{RRCaead}).

To complete the N2 handover procedure, at step 12, the target RAN 230 sends a handover notify message to the AMF 710. The source AMF 240, at step 10a, sends a UE context release command to the source RAN 220, and the source RAN 220, at step 10b, sends a UE context release complete message to the AMF 710.

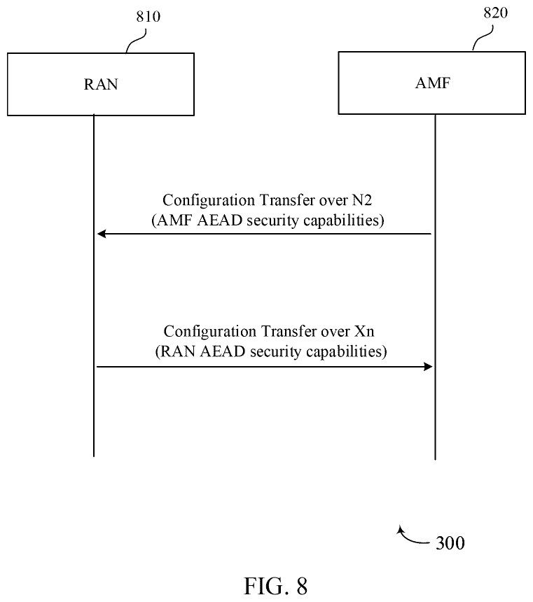

In some embodiments, a RAN (e.g., the source RAN 220 and/or the target RAN 230) may exchange configuration information with an AMF (e.g., the AMF 710) during a configuration transfer procedure. FIG. 8 illustrates a configuration information exchange 800 between a RAN 810 and an AMF 820 in accordance with aspects of the present disclosure.

For example, at power up, restart, and/or when modifications are applied, the RAN 810 and the AMF 820 may exchange configuration information (e.g., supported AEAD algorithms, AEAD modes, key derivation capabilities) over non-UE related N2 signaling. As shown, the AMF 820 may perform a configuration transfer of the AMF's AEAD security capabilities over the N2 interface, and the RAN 810 may perform a configuration transfer of the RAN's AEAD security capabilities over the N2 interface.

Example configuration information that may be transferred from the AMF 820 includes: (1) the name of the AMF 820 and the globally unique AMF identifier (GUAMI) configured for the AMF name, (2) a set of transport network layer (TNL) associations to be established between the RAN 810 and the AMF 820, (c) a weight factor associated with each of the TNL associations within the AMF 820, (4) a weight factor for each AMF name within the AMF set, (e) for each GUAMI a corresponding backup AMF name, (f) a list of supported AEAD ciphering algorithms, (g) a list of supported AEAD integrity protection algorithms, (h) usage 256-bit NAS Key capabilities, and so on.

Example configuration information that may be transferred from the RAN 810 includes: (a) information about tracking areas served by the RAN 810, (b) network slice selection assistance information (S-NSSAI) for network slices supported by the RAN 810, (c) a list of supported AEAD ciphering algorithms, (d) a list of supported integrity protection algorithms, (e) usage 256-bit AS Key capabilities, and so on.

In some embodiments, an RNA update procedure may utilize AEAD algorithms and AEAD modes for ciphering and integrity protection. For example, a UE triggered RNA update procedure (e.g., triggered periodically or based on movement of a UE), involving context retrieval over an Xn interface, may facilitate the negotiation of AEAD algorithms and AEAD modes between a UE (e.g., the UE 210) and a network.

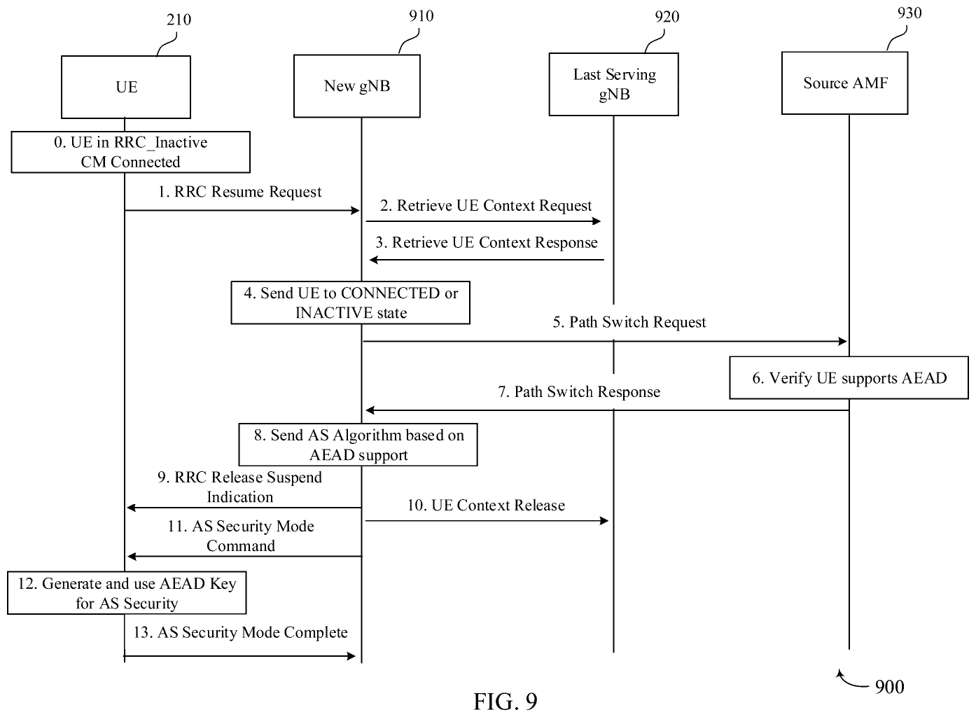

FIG. 9 illustrates an example messaging flow 900 during an RNA Update procedure in accordance with aspects of the present disclosure. The messaging flow 900 may implement various aspects of the present disclosure described herein. For example, the messaging flow 900 may include the UE 210, a new gNB 910, a last serving gNB 920, and a source AMF 930, which may be examples of UEs, gNBs, and AMFs as described herein. In the following description of the messaging flow 900, the operations between the UE 210, the new gNB 910, the last serving gNB 920, and the source AMF 930 may be performed in different orders or at different times. Some operations may also be omitted, or other operations may be added. Although the UE 210, the new gNB 910, the last serving gNB 920, and the source AMF 930 are shown performing the operations of the messaging flow 900, some aspects of some operations may also be performed by other entities of the messaging flow 900 or by entities that are not shown in the messaging flow 900, or any combination thereof.

At step 0, the UE 210 is in an RRC INACTIVE state (e.g., CM connected). At step 1, the UE 210 sends an RRC Resume Request to the new gNB 910. For example, the UE 210, resuming from the inactive state, transmits an inactive radio network temporary identifier (I-RNTI) allocate to the UE 210 by the last serving gNB 920, and a cause value, such as an RNA update.

At step 2, the new gNB 910 sends a retrieve UE context request to the last serving gNB 920. For example, the new gNB 910, if able to resolve a gNB identity contained in the I-RNTI, sends a request (e.g., with the cause value) to the last serving gNB 920 to provide a UE context.

At step 3, the last serving gNB 920 sends a retrieve UE context response to the new gNB 910. The UE context may include the AEAD security capabilities for the UE 210, an indication of used ABAD keys, and so on. In some cases, the last serving gNB 920 may move the UE 210 to an RR IDLE state and/or maintain the UE context of the last serving gNB 920 and maintain the UE 210 in the RRC_INACTIVE state.

For example, the last serving gNB 920 may send an RRCRelease message to move the UE 210 to the RRC_IDLE state. As another example, the last serving gNB 920 stores received information to be used in a next resume attempt (e.g., C-RNTI and physical cell identity (PCI) related to the resumption gNB) and responds to the new gNB 910 with a RETRIEVE UE CONTEXT FAILURE message including an encapsulated RRCRelease message (e.g., including a Suspend Indication).

At step 4, the new gNB 910 sends the UE 210 to the CONNECTED or INACTIVE state. For example, the new gNB 910 moves the UE 210 to the RRC CONNECTED state or may send the UE 210 back to the RRC_IDLE state (e.g., where an RRCRelease message is sent by the new gNB 910) or send the UE 210 back to the RRC_INACTIVE state.

In some cases, during transitions from RRC_INACTIVE to RRC_CONNECTED states, the new gNB 910 determines to select and apply the combined authenticated encryption algorithms with AEAD modes (e.g., for AS security, such as RRC integrity and ciphering protection and UP integrity and ciphering protection) when the received UE security capabilities support combined authenticated encryption algorithms and AEAD modes and when operator configuration policy includes combined authenticated encryption algorithms and AEAD modes in a prioritized list. When new gNB 910 determines to apply combined authenticated encryption algorithms and AEAD modes for AS (e.g., RRC and UP) security, based on a “Use AEAD AS key indication,” the new gNB 910 derives the AEAD RRC key (K_{RRCaead}) and AEAD UP key (K_{UPaead}).

The new gNB 910 selects the combined authenticated encryption algorithm and AEAD mode with a highest priority from the received 5G security capabilities (based on supported combined authenticated encryption algorithms and AEAD modes Security capabilities) of the UE 210 according to prioritized locally configured list of combined authenticated encryption algorithms and AEAD modes (e.g., for both integrity and ciphering). When the new gNB 910 selects the same security algorithms as the last serving gNB 920, the new gNB 910 uses the selected algorithms to derive an AEAD RRC key (K_{RRCaead}) to protect the RRCResume message and send to the UE 210 on SRB1, and additionally send the “Use AEAD AS key indication.” In some cases, when loss of downlink user data buffered in the last serving gNB 920 is to be prevented, the new gNB 920 provides forwarding addresses.

At step 5, the new gNB 910 sends a path switch request to the source AMF 930. For example, the new gNB 910 send a path switch request that includes the AEAD security capabilities of the UE 210 to the source AMF 930.

At step 6, the source AMF 930 verifies that the UE supports AEAD for ciphering and integrity protection. For example, the source AMF 930 may search locally stored UE information to determine whether the received AEAD security capabilities match what is stored by the source AMF 930.

At step 7, the source AMF 930 sends a path switch response message to the new gNB 910. When there is a mismatch, the source sends its locally stored AEAD security capabilities for the UE 210.

At step 8, the new gNB 910 sends an AS algorithm based on AEAD support by the UE 210. For example, the new gNB 910 establishes RRC security (or earlier, at step 4), directly performing an AS (e.g., UP) security mode command procedure of the messaging flow 900. The new gNB 910 may determine to select and apply combined authenticated encryption algorithms and AEAD modes, as described herein. The new gNB 910 may derive the AEAD RRC key (K_{RRCaead}) and the AEAD UP key (K_{UPaead}). In some cases, the new gNB 910 selects combined authenticated encryption algorithms and AEAD modes algorithm with highest priorities from the received AEAD security capabilities of the UE 210 and according to a prioritized locally configured list of combined authenticated encryption algorithms and AEAD modes (e.g., for both integrity and ciphering algorithms).

At step 9, the new gNB 910 sends an RRC Release Suspend indication to the UE 210. For example, the new gNB 910 may maintain the UE 210 in the RRC INACTIVE state by sending the RRCRelease with a suspend indication and a “Use AEAD AS key indication.”

At step 10, the new gNB 910 sends a UE context release message to the last serving gNB 920. For example, the UE context release message may trigger the release of the UE resources as the last serving gNB 920.

At step 11, the new gNB 910 sends an AS security mode command to the UE 210. For example, when the new gNB 910 does not support the received algorithms or when the new gNB 910 has a preference to utilize different algorithms, the new gNB 910 may send an RRCSetup message on SRB0 in order to proceed with RRC connection establishment as if the UE 210 was in the RRC_IDLE state (e.g., a fallback procedure). The UE 210 may then perform NAS based RRC recovery and negotiate a suitable algorithm with the new gNB 910 via an AS SMC procedure, as described herein.

In some cases, the new gNB 910 may initiate the AS SMC procedure, where the new gNB 910 determines to select and apply combined authenticated encryption algorithms and AEAD modes based on the received UE security capabilities and when the operator configuration policy includes combined authenticated encryption algorithms and AEAD modes in a prioritized list, as described herein. The new gNB 910 may derive the AEAD RRC key (K_{RRCaead}) and AEAD UP key (K_{UPaead}), and activate the RRC integrity protection before sending the AS Security Mode Command message. The AS security mode command message may contain the selected combined authenticated encryption algorithms and AEAD modes for RRC and UP encryption and integrity and may also contain the “Use AEAD AS key indication,” and may be integrity protected with the AEAD RRC key (K_{RRCaead}) based on the current KgNB and using the selected combined authenticated encryption algorithms and AEAD modes (e.g., int-only) for integrity protection.

At step 12, the UE 210 generates and uses the AEAD Key for AS security. The UE 210 may determine to derive and use the AEAD AS keys (e.g., the RRC key (K_{RRCaead}) and the AEAD UP key (K_{UPaead}) based on the received selected RRC and UP algorithms or based on the received “Use AEAD key indication.” The UE 210 may verify the AS Security Mode Command message, such as by verifying the integrity protection using the indicated combined authenticated encryption algorithms and AEAD modes (e.g., int-only) and the AEAD RRC key (K_{RRCaead}).

At step 13, the UE 210 sends an AS Security Mode Complete message to the new gNB 910. For example, the AS Security Mode Complete message is integrity protected with the selected RRC combined authenticated encryption algorithm with AEAD mode (e.g., int-only) indicated in the AS security mode command message and the AEAD RRC key (K_{RRCaead}) based on the current K_{gNB}.

In some embodiments, a dual connectivity procedure may utilize AEAD algorithms and AEAD modes for ciphering and integrity protection. For example, a dual connectivity procedure may establish a same level of security during a dual connectivity, such as when a UE (e.g., the UE 210) connects to multiple RAN Nodes within a 5G CN. For example, Dual Connectivity enables a UE to connect to one gNB (or ng-eNB) that acts as an MN and one gNB (or ng-eNB) that acts as an SN, where the MN is connected to the 5GC while the SN is connected to the MN via an Xn interface.

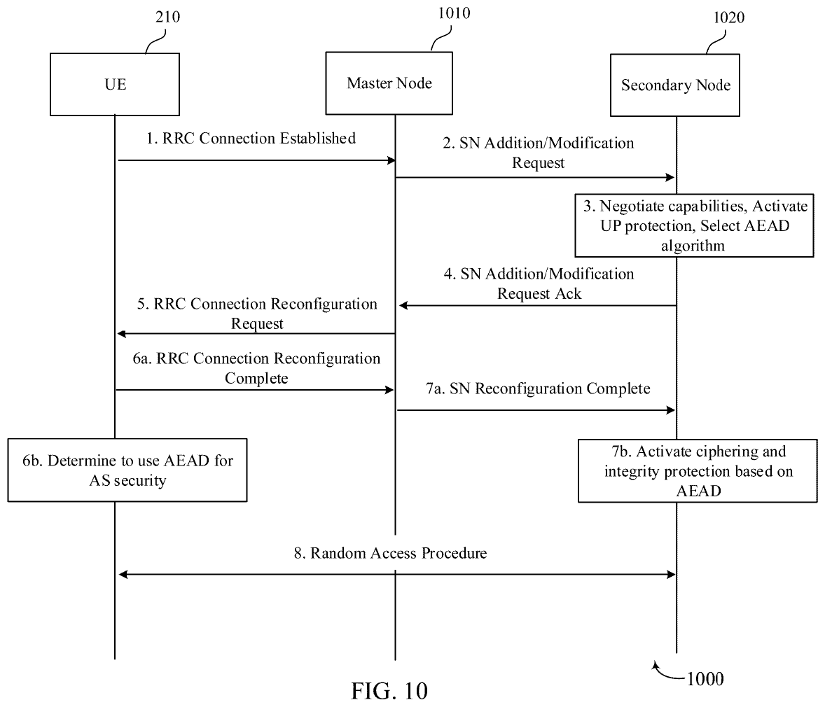

FIG. 10 illustrates an example messaging flow 1000 during a Dual Connectivity procedure in accordance with aspects of the present disclosure. The messaging flow 1000 may implement various aspects of the present disclosure described herein. For example, the messaging flow 1000 may include the UE 210, an MN 1010, and an SN 1020, which may be examples of UEs and RAN nodes as described herein. In the following description of the messaging flow 1000, the operations between the UE 210, the MN 1010 and the SN 1020 may be performed in different orders or at different times. Some operations may also be omitted, or other operations may be added. Although the UE 210, the MN 1010 and the SN 1020 are shown performing the operations of the messaging flow 1000, some aspects of some operations may also be performed by other entities of the messaging flow 1000 or by entities that are not shown in the messaging flow 1000, or any combination thereof.

At step 1, an RRC Connection is established between the UE 210 and the MN 1010. At step 2, the MN 1010 sends an SN addition/modification request to the SN 1020. For example, the MN 1010 sends the SN addition/modification request to the SN 1020 over the Xn-C interface to negotiate the available resources, configuration, and algorithms at the SN 1020. The MN 1010 may compute and deliver a K_{SN} to the SN 1020 if a new key is needed. The MN 1010 may also send AEAD security capabilities for the UE 210, as well as a “Use AEAD AS key indication,” and an UP security policy received from an SMF. In some cases, such as during a PDU split, an UP integrity protection and ciphering activation decision from MN 1010 may be also included (e.g., as described in TS 33.501 subclause 6.10.4).

In some cases, such as when the MN 1010 determines to configure a conditional PSCell addition (CPA) or conditional PSCell change (CPC), the MN 1010 MN may derive a different K_{SN} for each candidate SN, and deliver the K_{SN} separately to each candidate SN.

At step 3, the SN 1020 negotiates capabilities, activates UP protection, and/or selects an AEAD algorithm. For example, the SN 1020 may allocate resources and determine to select and apply combined authenticated encryption algorithms and AEAD modes based on an operator configuration policy that includes combined authenticated encryption algorithms and AEAD modes in a prioritized list. If the SN 1020 determines to apply combined authenticated encryption algorithms and AEAD modes for AS (e.g., RRC and UP) security, based on a “Use AEAD AS key indication,” the SN 1020 derives the AEAD RRC key (K_{RRCaead}) and the AEAD UP key (K_{UPaead}). The SN 1020 may select the combined authenticated encryption algorithms and AEAD modes with a highest priority from the received 5G security capabilities according to a prioritized locally configured list of combined authenticated encryption algorithms and AEAD modes (e.g., for both integrity and ciphering algorithms).

In some cases, when a new K_{SN} was delivered to the SN 1020, then the SN 1020 calculates the associated RRC. The SN 1020 may derive the UP keys at the same time as deriving the RRC key, and activate the UP security policy (e.g., as described in TS 33.501 subclause 6.10.4).

At step 4, the SN 1020 sends an SN addition/modification request acknowledgment message to the MN 1010. For example, the SN addition/modification request acknowledgment message indicates an availability of requested resources and identifiers for the selected combined authenticated encryption algorithms and AEAD modes for requested DRBs and/or signal radio bearer (SRB) for the UE 210, along with the “Use AEAD AS key indication.” The SN 1020 may also send UP integrity protection and encryption indications related to combined authenticated encryption algorithms and AEAD modes to the MN 1010.

At step 5, the MN 1010 sends an RRC Connection Reconfiguration request message to the UE 210. For example, the RRC Connection Reconfiguration request message may include an instruction to configure the new DRBs and/or SRB for the SN 1020. The MN 1010 may include an SN counter parameter to indicate a new K_{SN} is needed (e.g., to be computed by the UE 210 for the SN 1020). The MN 1010 may forward UE configuration parameters (e.g., containing the combined authenticated encryption algorithms and AEAD modes related algorithm identifiers received from the SN 1020), the “Use AEAD AS key indication,” and UP integrity protection and encryption indications to the UE 210 (as depicted in subclause 6.10.3.3).

In some cases, such as when the SN 1020 sends more than one candidate PScell SCG configuration, the MN 1010 signals to the UE 210 that all these configurations are associated with the same SN counter value. Further, the message is sent over the RRC connection and is integrity protected using the K_{RRCint} of the MN 1010 (e.g., protecting the SN counter value).

At steps 6a-b, the UE 210 sends an RRC Connection Reconfiguration Complete message to the MN 1010 and determines to use AEAD for AS security. For example, the UE 210 may determine to derive and use AEAD AS keys (e.g., the AEAD RRC key (K_{RRCaead}) and AEAD UP Key (K_{UPaead})) based on the received selected RRC and UP algorithms and/or based on the received “Use AEAD AS key indication.” Further, the UE 210 may determine to use combined authenticated encryption algorithms and AEAD modes for ciphering and integrity protection based on the combined authenticated encryption algorithms and AEAD modes received for the associated SRB and/or DRBs.

In some cases, the UE 210 accepts the RRC Connection Reconfiguration Request after validating its integrity. The UE 210 computes the K_{SN} for the SN 1020 if an SN counter parameter was included and sends the RRC Reconfiguration Complete to the MN 1010. The UE 210 activates the selected encryption/decryption and integrity protection keys with the SN 1020.

At steps 7a-b, the MN 1010 sends an SN Reconfiguration Complete message to the SN 1020, and the SN 1020 activates ciphering and integrity protection based on AEAD. For example, the MN 1010 sends the SN Reconfiguration Complete message over an Xn-C interface to inform the SN 1020 of the configuration result. Once received, the SN 1020 may activate the selected encryption/decryption and integrity protection with the UE 210 and uses the AEAD RRC and UP keys. When the SN 1020 does not activate encryption/decryption and integrity protection with the UE 210 at this stage, the SN 1020 activate encryption/decryption and integrity protection upon receiving a Random Access request from the UE 210. At step 8, the UE 210 and the SN 1020 perform the random access procedure, using the selected AS security.

In some embodiments, the entities described herein (the UE 210, the AMFs, and so on), when deriving keys for NAS/AS integrity, NAS/AS encryption, and/or NAS/AS authenticated encryption algorithms from the K_{AMF}, may utilize the following parameters to form the string S: FC=0×69, P0=algorithm type distinguisher specific to AEAD, L0=AEAD, length of algorithm type distinguisher (e.g., 0×00 0×01), P1=algorithm identity specific to L1=length of algorithm identity (e.g., 0×00 0×01), P2=AEAD mode distinguisher (E2M/M2E/EncOnly/IntOnly, and L2=length of AEAD mode distinguisher (i.e. 0×00 0×01).

The algorithm type distinguisher may be N-NAS-enc-alg for NAS encryption algorithms and N-NAS-int-alg for NAS integrity protection algorithms. For NAS authenticated encryption algorithms, the algorithm type distinguisher may be N-NAS-authenc-alg or N-NAS-encint-alg. The algorithm type distinguisher may be N-RRC-enc-alg for RRC encryption algorithms, N-RRC-int-alg for RRC integrity protection algorithms, and, for RRC authenticated encryption algorithms, N-RRC-authenc-alg or N-RRC-encint-alg. Further, the algorithm type distinguisher may be N-UP-enc-alg for UP encryption algorithms, N-UP-int-alg for UP integrity protection algorithms, and N-UP-authenc-alg or N-UP-encint-alg for UP authenticated encryption algorithms (as depicted in table 1). The values 0×00 and 0×07 to 0×f0 may be reserved for future use, and the values 0×f1 to 0×ff may be reserved for private use.

TABLE 1
Algorithm type distinguishers

| Algorithm distinguisher | Value |
|---|---|
| N-NAS-enc-alg | 0x01 |
| N-NAS-int-alg | 0x02 |
| N-RRC-enc-alg | 0x03 |
| N-RRC-int-alg | 0x04 |
| N-UP-enc-alg | 0x05 |
| N-UP-int-alg | 0x06 |
| N-NAS-authenc-alg (or) | 0x07 |
| N-NAS-encint-alg | |
| N-RRC-authenc-alg (or) | 0x08 |
| N-RRC-encint-alg | |
| N-UP-authenc-alg (or) | 0x09 |
| N-UP-encint-alg | |

Table 2 lists different possible AEAD mode distinguishers or indications to indicate different AEAD mode usage for NAS signaling security, RRC security, or UP security, respectively.

TABLE 2
AEAD Mode distinguishers

| Algorithm distinguisher | Value |
|---|---|
| N-NAS-AEAD-E2M-mode | 0x01 |
| N-NAS-AEAD-M2E-mode | 0x02 |
| N-NAS-AEAD-EncOnly-mode | 0x03 |
| N-NAS-AEAD-IntOnly-mode | 0x04 |
| N-RRC-AEAD-E2M-mode | 0x05 |
| N-RRC-AEAD-M2E-mode | 0x06 |
| N-RRC-AEAD-EncOnly-mode | 0x07 |
| N-RRC-AEAD-IntOnly-mode | 0x08 |
| N-UP-AEAD-E2M-mode | 0x09 |
| N-UP-AEAD-M2E-mode | 0x10 |
| N-UP-AEAD-EncOnly-mode | 0x11 |
| N-UP-AEAD-IntOnly-mode | 0x12 |

An algorithm identity, in some cases, may be placed into the four least significant bits of the octet, where the two least significant bits of the four most significant bits are reserved for future use, and the two most significant bits of the most significant nibble are reserved for private use. The entire four most significant bits are set to all zeros.

In some cases, the network entities may derive the AEAD NAS security key using the 256-bit K_{AMF} as an input key. For an algorithm key of length n bits, where n is less or equal to 256 or 512 or higher, the n least significant bits of the 256 bits of the KDF output can be used as the algorithm key.

In some embodiments, a nonce, which is used by AEAD algorithms to ensure uniqueness and integrity, may be constructed of multiple parameters, such as a UE ID known to the UE 210 and the other network entities (e.g., an authenticated unique secret permanent identifier or privacy protected temporary identifier of the UE/subscriber, such as any of IMSI/NAI/SUPI/verified GUTI, Timestamp, or other parameters used in other cipher/integrity algorithms).

In some embodiments, the AEAD algorithms can include associated data (AD), such as the multiple parameters associated with the nonce construction (e.g., an authenticated unique secret permanent identifier or privacy protected temporary identifier of the UE/subscriber, such as any of IMSI/NAI/SUPI/verified GUTI, Timestamp, or other parameters used in other cipher/integrity algorithms).

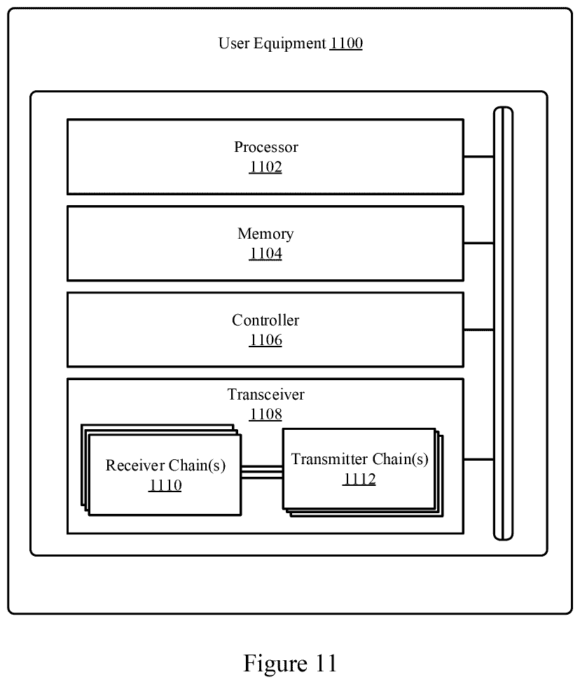

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general- purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to support a means for receiving, from a network entity, a handover command message that contains security information, including one or more AEAD algorithms and one or more AEAD modes associated with the one or more AEAD algorithms, generating an AEAD security key based on the one or more AEAD algorithms and the one or more AEAD modes, and initiating RRC integrity and ciphering protection using the derived AEAD security key, the one or more AEAD algorithms, and the one or more AEAD modes.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receive the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

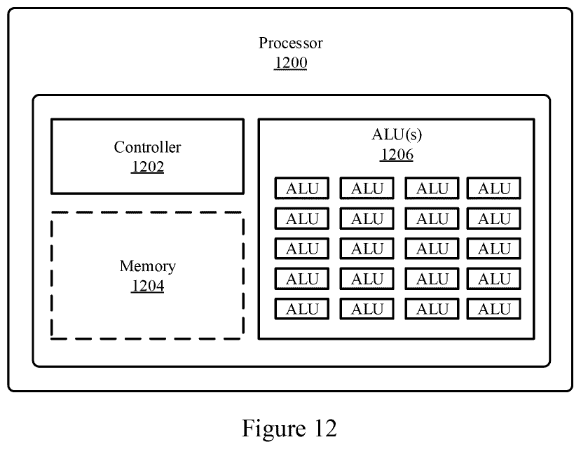

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support a means for receiving, from a network entity, a handover command message that contains security information, including one or more AEAD algorithms and one or more AEAD modes associated with the one or more AEAD algorithms, generating an AEAD security key based on the one or more AEAD algorithms and the one or more AEAD modes, and initiating RRC integrity and ciphering protection using the derived AEAD security key, the one or more AEAD algorithms, and the one or more AEAD modes.

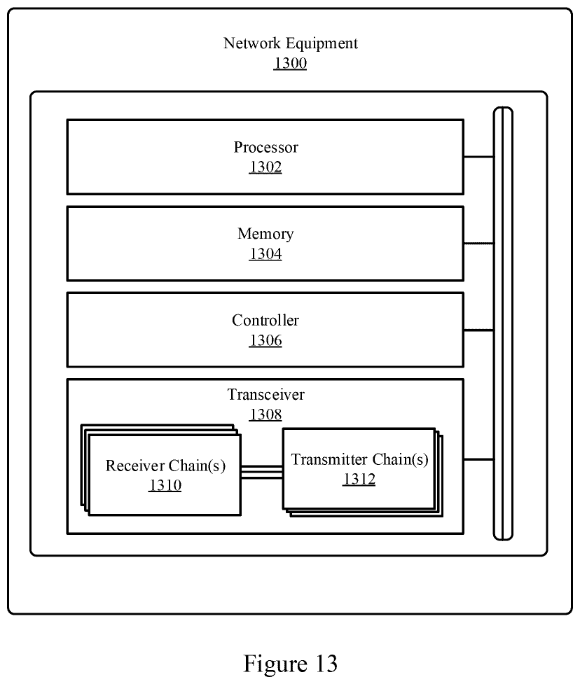

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such the memory 1304 or another type of memory. Computer-readable media includes both non- transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to support a means for receiving a handover request message that contains security information, including one or more AEAD algorithms and one or more AEAD modes associated with the one or more AEAD algorithms, generating an AEAD security key based on the one or more AEAD algorithms and the one or more AEAD modes, and transmitting a handover request acknowledgement message that includes a handover command, wherein the handover command is associated with a selected AEAD algorithm and a selected AEAD mode.

As another example, the NE 1300 may be configured to support a means for receiving a path switch message during an RNA procedure requested by a UE, and initiating a security mode procedure with the UE, wherein the security mode procedure is based on one or more AEAD algorithms and one or more AEAD modes associated with the one or more AEAD algorithms.

As another example, the NE 1300 may be configured to support a means for receiving an addition/modification request from a master RAN node connected to a UE during a dual connectivity procedure, wherein the addition/modification request message indicates security capabilities for the UE, selecting one or more AEAD algorithms and one or more AEAD modes associated with the one or more AEAD algorithms to apply to communications with the UE based on the security capabilities for the UE, and transmitting an addition/modification request acknowledgement message that indicates the selected one or more AEAD algorithms and the one or more AEAD modes.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receive the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the processing the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

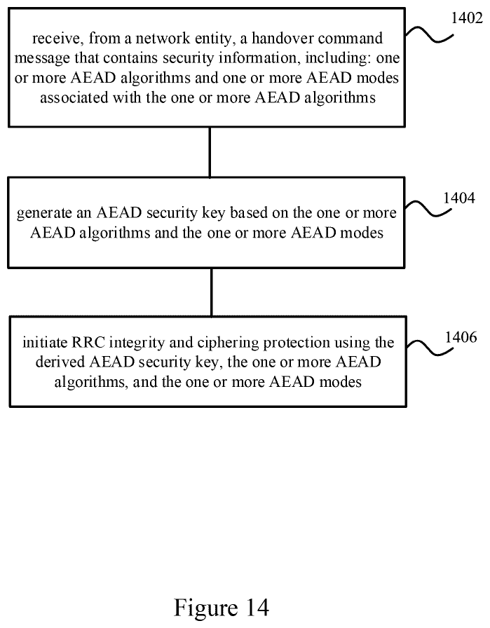

FIG. 14 illustrates a flowchart of a method in accordance with aspects of the present disclosure. The operations of the method may be implemented by a UE as described herein. In some implementations, the UE may execute a set of instructions to control the function elements of the UE to perform the described functions.

At 1402, the method may include receiving, from a network entity, a handover command message that contains security information, including one or more AEAD algorithms and one or more AEAD modes associated with the one or more AEAD algorithms. The operations of 1402 may be performed in accordance with examples as described herein. In some implementations, aspects of the operations of 1402 may be performed by a UE as described with reference to FIG. 11.

At 1404, the method may include generating an AEAD security key based on the one or more AEAD algorithms and the one or more AEAD modes. The operations of 1404 may be performed in accordance with examples as described herein. In some implementations, aspects of the operations of 1404 may be performed a UE as described with reference to FIG. 11.

At 1406, the method may include initiating RRC integrity and ciphering protection using the derived AEAD security key, the one or more AEAD algorithms, and the one or more AEAD modes. The operations of 1406 may be performed in accordance with examples as described herein. In some implementations, aspects of the operations of 1406 may be performed a UE as described with reference to FIG. 11.

It should be noted that the method described herein describes a possible implementation, and that the operations and the steps may be rearranged or otherwise modified and that other implementations are possible.

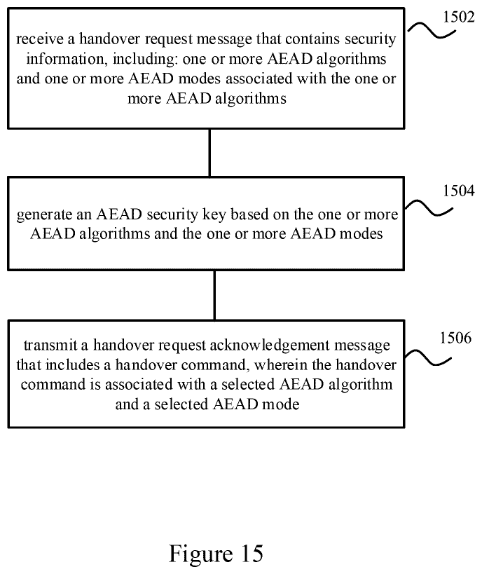

FIG. 15 illustrates a flowchart of a method in accordance with aspects of the present disclosure. The operations of the method may be implemented by an NE (e.g., a target RAN node) as described herein. In some implementations, the NE may execute a set of instructions to control the function elements of the NE to perform the described functions.

At 1502, the method may include receiving a handover request message that contains security information, including one or more AEAD algorithms and one or more AEAD modes associated with the one or more AEAD algorithms. The operations of 1502 may be performed in accordance with examples as described herein. In some implementations, aspects of the operations of 1502 may be performed by an NE as described with reference to FIG. 13.

At 1504, the method may include generating an AEAD security key based on the one or more AEAD algorithms and the one or more AEAD modes. The operations of 1504 may be performed in accordance with examples as described herein. In some implementations, aspects of the operations of 1504 may be performed by an NE as described with reference to FIG. 13.

At 1506, the method may include and transmitting a handover request acknowledgement message that includes a handover command, wherein the handover command is associated with a selected AEAD algorithm and a selected AEAD mode. The operations of 1506 may be performed in accordance with examples as described herein. In some implementations, aspects of the operations of 1506 may be performed by an NE as described with reference to FIG. 13.

It should be noted that the method described herein describes a possible implementation, and that the operations and the steps may be rearranged or otherwise modified and that other implementations are possible.

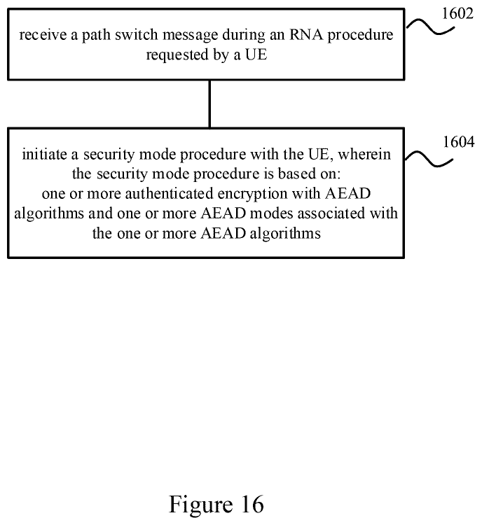

FIG. 16 illustrates a flowchart of a method in accordance with aspects of the present disclosure. The operations of the method may be implemented by an NE (e.g., a base station, such as a gNB) as described herein. In some implementations, the NE may execute a set of instructions to control the function elements of the NE to perform the described functions.

At 1602, the method may include receiving a path switch message during an RNA procedure requested by a UE. The operations of 1602 may be performed in accordance with examples as described herein. In some implementations, aspects of the operations of 1602 may be performed by an NE as described with reference to FIG. 13.

At 1604, the method may include initiating a security mode procedure with the UE, wherein the security mode procedure is based on one or more AEAD algorithms and one or more AEAD modes associated with the one or more AEAD algorithms. The operations of 1604 may be performed in accordance with examples as described herein. In some implementations, aspects of the operations of 1604 may be performed by an NE as described with reference to FIG. 13.

It should be noted that the method described herein describes a possible implementation, and that the operations and the steps may be rearranged or otherwise modified and that other implementations are possible.

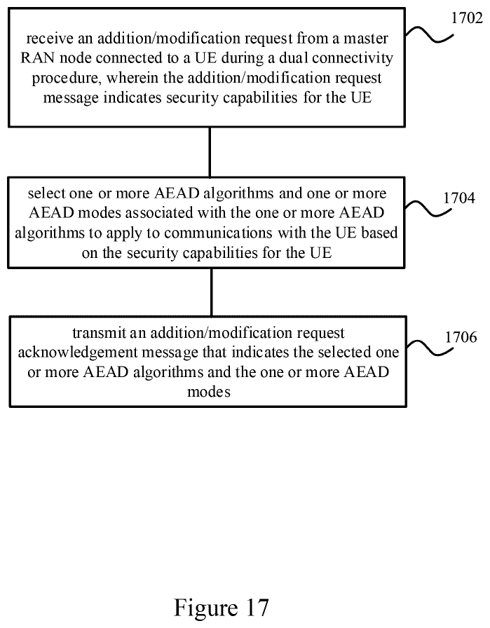

FIG. 17 illustrates a flowchart of a method in accordance with aspects of the present disclosure. The operations of the method may be implemented by an NE (e.g., a RAN node) as described herein. In some implementations, the NE may execute a set of instructions to control the function elements of the NE to perform the described functions.

At 1702, the method may include receiving an addition/modification request from a master RAN node connected to a UE during a dual connectivity procedure, wherein the addition/modification request message indicates security capabilities for the UE. The operations of 1702 may be performed in accordance with examples as described herein. In some implementations, aspects of the operations of 1702 may be performed by an NE as described with reference to FIG. 13.

At 1704, the method may include selecting one or more AEAD algorithms and one or more AEAD modes associated with the one or more AEAD algorithms to apply to communications with the UE based on the security capabilities for the UE. The operations of 1704 may be performed in accordance with examples as described herein. In some implementations, aspects of the operations of 1704 may be performed by an NE as described with reference to FIG. 13.

At 1706, the method may include transmitting an addition/modification request acknowledgement message that indicates the selected one or more AEAD algorithms and the one or more AEAD modes. The operations of 1706 may be performed in accordance with examples as described herein. In some implementations, aspects of the operations of 1706 may be performed by an NE as described with reference to FIG. 13.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity, a handover command message that contains security information, including:
one or more authenticated encryption with associated data (AEAD) algorithms; and
one or more AEAD modes associated with the one or more AEAD algorithms;
generate an AEAD security key based on the one or more AEAD algorithms and the one or more AEAD modes; and
initiate radio resource control (RRC) integrity and ciphering protection using the derived AEAD security key, the one or more AEAD algorithms, and the one or more AEAD modes.

2. The UE of claim 1, wherein the at least one processor is further configured to cause the UE to:
transmit a handover complete message after initiating the RRC integrity and ciphering protection.

3. The UE of claim 1, wherein the handover command message is received from a source radio access network (RAN) node during an Xn handover procedure.

4. The UE of claim 1, wherein the handover command message is received from a source radio access network (RAN) node during an N2 handover procedure.

5. The UE of claim 1, wherein the handover command message is received from a new serving base station during a radio access network (RAN) notification area (RNA) update procedure.

6. The UE of claim 1, wherein the one or more AEAD algorithms include a SNOW-3G based algorithm, an advanced encryption standard (AES) based algorithm, or a ZUC based algorithm.

7. The UE of claim 1, wherein the one or more AEAD modes include:
an encrypt-then-MAC (EtM) mode;
a MAC-then-encrypt (MtE) mode;
an encryption only mode; or
an integrity only mode.

8. A target radio access network (RAN) node for wireless communication, comprising:
at least one memory; and
at least one processor coupled with the at least one memory and configured to cause the target RAN node to:
receive a handover request message that contains security information, including:
one or more authenticated encryption with associated data (AEAD) algorithms; and
one or more AEAD modes associated with the one or more AEAD algorithms;
generate an AEAD security key based on the one or more AEAD algorithms and the one or more AEAD modes; and
transmit a handover request acknowledgement message that includes a handover command,
wherein the handover command is associated with a selected AEAD algorithm and a selected AEAD mode.

9. The target RAN node of claim 8, wherein the one or more AEAD algorithms include a SNOW-3G based algorithm, an advanced encryption standard (AES) based algorithm, or a ZUC based algorithm.

10. The target RAN node of claim 8, wherein the one or more AEAD modes include:
an encrypt-then-MAC (EtM) mode;
a MAC-then-encrypt (MtE) mode;
an encryption only mode; or
an integrity only mode.

11. The target RAN node of claim 8, wherein the handover request message is received from a source RAN node during an Xn handover procedure.

12. The target RAN node of claim 11, wherein the at least one processor is further configured to cause the target RAN node to:
receive a handover complete message from a user equipment (UE) associated with the Xn handover procedure; and
transmit a path switch request message to a source access and mobility function (AMF) associated with the source RAN node that includes AEAD capability information for the UE.

13. The target RAN node of claim 8, wherein the handover request message is received from a target access and mobility function (AMF) during an N2 handover procedure.

14. The target RAN node of claim 8, wherein the handover request message is received from an access and mobility function (AMF) associated with the target RAN node and a source RAN node during an N2 handover procedure.

15. A base station for wireless communication, comprising:
at least one memory; and
at least one processor coupled with the at least one memory and configured to cause the base station to:
receive a path switch message during a radio access network (RAN) notification area (RNA) procedure requested by a user equipment (UE); and
initiate a security mode procedure with the UE, wherein the security mode procedure is based on:
one or more authenticated encryption with associated data (AEAD) algorithms; and
one or more AEAD modes associated with the one or more AEAD algorithms.

16. The base station of claim 15, wherein the base station receives the path switch message from a source access and mobility function (AMF) associated with a last serving base station for the UE.

17. The base station of claim 15, wherein the one or more AEAD algorithms include a SNOW-3G based algorithm, an advanced encryption standard (AES) based algorithm, or a ZUC based algorithm.

18. The base station of claim 15, wherein the one or more AEAD modes include:
an encrypt-then-MAC (EtM) mode;
a MAC-then-encrypt (MtE) mode;
an encryption only mode; or
an integrity only mode.

19. A radio access network (RAN) node for wireless communication, comprising:
at least one memory; and
at least one processor coupled with the at least one memory and configured to cause the RAN node to:
receive an addition/modification request from a master RAN node connected to a user equipment (UE) during a dual connectivity procedure,
wherein the addition/modification request message indicates security capabilities for the UE;
select one or more authenticated encryption with associated data (AEAD) algorithms and one or more AEAD modes associated with the one or more AEAD algorithms to apply to communications with the UE based on the security capabilities for the UE; and
transmit an addition/modification request acknowledgement message that indicates the selected one or more AEAD algorithms and the one or more AEAD modes.

20. The RAN node of claim 19, wherein the one or more AEAD algorithms include a SNOW-3G based algorithm, an advanced encryption standard (AES) based algorithm, or a ZUC based algorithm; and
wherein the one or more AEAD modes include:
an encrypt-then-MAC (EtM) mode;
a MAC-then-encrypt (MtE) mode;
an encryption only mode; or
an integrity only mode.
